(19) United States
(12) Patent Application Publication
(10) Pub. No.: US 2015/0295960 A1
(43) Pub. Date: Oct. 15, 2015

(54) Collaborative Multimedia Conversation Manager

(71) Applicant: GENBAND US LLC, Frisco, TX (US)

(72) Inventors: Arjun Cholkar, Frisco, TX (US); Don Gilchrist, Ottawa (CA); Ibrahim Dogru, Istanbul (TR); Anthony Jones, Firsco, TX (US)

(21) Appl. No.: 14/684,026

(22) Filed: Apr. 10, 2015

Related U.S. Application Data
(60) Provisional application No. 61/978,705, filed on Apr. 11, 2014.
(60) Provisional application No. 61/987,317, filed on May 1, 2014.

(51) Int. Cl. H04L 29/06; H04L 29/08

(52) U.S. Cl. CPC H04L 65/403; H04L 67/10

(57) ABSTRACT

A method performed by a conversation manager on a server in a communications network includes receiving a request from a first client device to establish a multimedia conversation with a second client device. The method further includes, establishing a communication session between the first client device and the second client device, the communication session comprising at least two different communication protocols for at least two different types of communication media. The method further includes receiving a request from the first client device or the second client device to add a third client device to the conversation, in response to the request. The method further includes establishing a communication session between the first client device or the second client device with the third client device, wherein the conversation manager is configured to add additional media types to the communication session in response to a request from one of the client devices.

### PRIORITY INFORMATION

The present application claims the benefit of U.S. Provisional Patent Application No. 61/978,705 filed Apr. 11, 2014 entitled “Collaborative Multimedia Communication” and U.S. Provisional Patent Application No. 61/987,317 filed May 1, 2014 entitled “Collaborative Multimedia Conversation Manager,” the disclosures of which are hereby incorporated by reference in their entirety.

### BACKGROUND

The present disclosure relates generally to communication management, and more particularly to methods and systems for intuitive multimedia communication.

People often communicate using various types of media. For example, people may engage in voice communication over the phone, whether by a landline, mobile phone, or voice over internet protocol (VOIP) applications. Additionally, users may use email and instant messaging applications. Other methods such as video conferencing and document sharing technologies are available as well.

In general, when one user is communicating with another user using one type of media and desires to use a second type of media, the user has to manually connect or set up a connection with the new media. For example, if a user is on a phone call with another user and desires to share his or her computer desktop with the other user, the user has to manually set up the desktop sharing with the other user. This typically involves sending a link via email to the other user.

Managing multiple applications and media types can often be a daunting task for a user. This can have an adverse effect on productivity. Additionally, this may be a source of frustration for a user. Thus, it is desirable to provide methods and systems that provide a better user experience for various communication applications.

### SUMMARY

According to one example, a method performed by a conversation manager on a server in a communications network includes receiving a request from a first client device to establish a multimedia conversation with a second client device. The method further includes, in response to the request, establishing a communication session between the first client device and the second client device, the communication session comprising at least two different communication protocols for at least two different types of communication media. The method further includes receiving a request from the first client device or the second client device to add a third client device to the conversation, in response to the request. The method further includes establishing a communication session between the first client device or the second client device with the third client device, wherein the conversation manager is configured to add additional media types to the communication session in response to a request from one of the client devices.

According to one example, a server includes a processor and a memory. The memory includes machine readable instructions that when executed by the system, cause the server to receive a request from a first client device to establish a multimedia conversation with a second client device. The machine readable instructions further cause the server to establish a communication session between the first client device and the second client device, the communication session comprising at least two different communication protocols for at least two different types of communication media. The machine readable instructions further cause the server to receive a request from the first client device or the second client device to add a third client device to the conversation, in response to the request. The machine readable instructions further cause the server to establish a communication session between the first client device or the second client device with the third client device, wherein the conversation manager is configured to add additional media types to the communication session in response to a request from one of the client devices.

According to one example, a non-transitory machine readable medium comprises machine readable instructions, the machine readable instructions comprising machine readable code for, in response to the request, establishing a communication session between the first client device and the second client device, the communication session comprising at least two different communication protocols for at least two different types of communication media. The machine readable instructions further comprising machine readable code for receiving a request from the first client device or the second client device to add a third client device to the conversation, in response to the request. The machine readable instructions further comprising machine readable code for establishing a communication session between the first client device or the second client device with the third client device, wherein the conversation manager is configured to add additional media types to the communication session in response to a request from one of the client devices.

According to one example, a method performed by a conversation manager on a server in a communications network includes establishing a first conversation between a first client device and a first plurality of client devices, the conversation including at least two different communication sessions comprising at least two different communication protocols for at least two different types of media. The method further includes receiving a request from the first client device to switch to a second conversation, the second conversation being between the first client device and a second plurality of client devices. The method further includes a step for putting at least one of the communication sessions from the first conversation in a hold state. The method further includes a step for establishing the second conversation between the first client device and the second plurality of client devices, the second conversation including at least two communication sessions using at least two different communication protocols for at least two different types of communication media.

According to one example, a server includes a processor and a memory. The memory includes machine readable instructions that when executed by the system, cause the server to establish a first conversation between a first client device and a first plurality of client devices, the conversation including at least two different communication sessions comprising at least two different communication protocols for at least two different types of media. The machine readable instructions further cause the server to receive a request from the first client device to switch to a second conversation, the second conversation being between the first client device and a second plurality of client devices. The machine readable instructions further cause the server to put at least one of the communication sessions from the first conversation in a hold state. The machine readable instructions further cause the server to establish the second conversation between the first client device and the second plurality of client devices, the second conversation including at least two communication sessions using at least two different communication protocols for at least two different types of communication media.

According to one example, a non-transitory machine readable medium comprises machine readable instructions, the machine readable instructions comprising machine readable code for establishing a first conversation between a first client device and a first plurality of client devices, the conversation including at least two different communication sessions comprising at least two different communication protocols for at least two different types of media. The machine readable instructions further comprising machine readable code for receiving a request from the first client device to switch to a second conversation, the second conversation being between the first client device and a second plurality of client devices. The machine readable instructions further comprising machine readable code for putting at least one of the communication sessions from the first conversation in a hold state. The machine readable instructions further comprising machine readable code for establishing the second conversation between the first client device and the second plurality of client devices, the second conversation including at least two communication sessions using at least two different communication protocols for at least two different types of communication media.

### BRIEF DESCRIPTION OF THE DRAWINGS

Aspects of the present disclosure are best understood from the following detailed description when read with the accompanying figures.

FIG. 1 is a diagram showing an illustrative network environment in which multiple users may communicate using multiple types of media, according to one example of principles described herein.

FIG. 2 is a diagram showing an illustrative client/server system, according to one example of principles described herein.

FIGS. 3A and 3B are diagrams illustrating a conversation manager establishing a conversation between multiple client devices, according to one example of principles described herein.

FIGS. 4A and 4B are diagrams illustrating a conversation manager switching between multi-party, multimedia conversations, according to one example of principles described herein.

FIG. 5 is a flowchart showing an illustrative method for establishing a multi-party, multimedia conversation, according to one example of principles described herein.

FIG. 6 is a flowchart showing an illustrative method for managing multiple multi-party, multimedia conversations, according to one example of principles described herein.

In the figures, elements having similar designations may or may not have the same or similar functions.

### DETAILED DESCRIPTION

In the following description, specific details are set forth describing some embodiments consistent with the present disclosure. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

As described above, a user of conventional systems has to manage multiple communication applications when communicating with different types of media. Managing multiple applications and media types can often be a daunting task for a user. This can have an adverse effect on productivity. Additionally, this may be a source of frustration for a user. Thus, it is desirable to provide methods and systems that provide a better user experience for various communication applications and allow a user to manage conversations involving multiple users and multiple media types.

According to principles described herein, a conversation manager is used to manage multimedia conversations between different devices associated with different users. For example, the conversation manager may manage communication sessions between multiple users who are communicating through any type of media such as voice, video, instant messaging, screen sharing, etc. Thus, the conversation manager is able to process communications using different types of communication protocols. Specifically, the conversation manager may use VOIP, Real-time Transfer Protocol (RTP), Session Initiation Protocol (SIP), Short Message Service (SMS), Hypertext Transfer Protocol (HTTP), and other communication protocols.

In one example, the conversation manager runs on a server system. The server system is in communication with a number of user devices. The user devices may have a client communication application, which will be referred to as the multimedia communication application. The multimedia communication applications running on various user devices may communicate with each other through the conversation manager or directly over a network such as the Internet. The conversation manager is capable of establishing conversations involving more than two people and more than one type of communication medium.

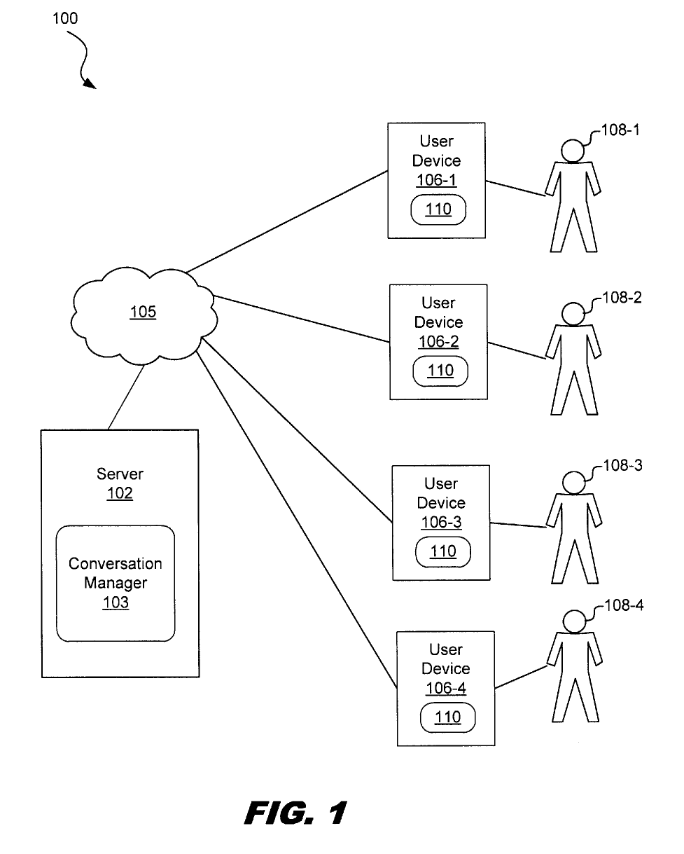

FIG. 1 is a diagram showing an illustrative network environment 100 in which multiple users 108 communicate using multiple types of media, according to one embodiment. According to the present example, the network environment 100 includes a server 102 and a number of devices 106. Each device 106 is associated with a particular user 108. Each device 106 also has a multimedia communication application 110 installed thereon. The multimedia communication applications 110 communicate over the network 105 with a conversation manager 103 running on the server 102.

The server 102 includes software and hardware that responds to requests over the network 105. Specifically, the server 102 receives requests from various devices 106 over the network 105. The server 102 then responds to those requests accordingly. Such requests may include requests to establish communication from one device 106 to another. In some examples, multiple servers 102 may be used in concert to perform the functions described herein.

The server 102 includes a communication application that will be referred to as the conversation manager 103. In this example, a conversation includes a communication involving two or more users and one or more types of media. Thus, the conversation manager 103 manages communication sessions involving one or more types of media and between two or more end user devices.

The network 105 may include various types of networks involving multiple types of physical media and transport protocols. For example, the network 105 may include a Local Area Network (LAN) using Ethernet, wireless, and fiber optic connections. The network 105 may also include the Internet. The network 105 may use various transmission protocols such as RTP, SIP, and HTTP to transmit data in the form of packets between user devices 106 and/or with the conversation manager 103. The network 105 may also include mobile data networks such as Long Term Evolution (LTE) networks. The scope of embodiments is not limited to ant particular network technology for use as, or in, network 105.

The user devices 106 may include a variety of different devices such as desktop computers, laptop computers, tablet computing devices, mobile smart phones and others. Different devices 106 may have different media capabilities. For example, desktop computers, laptop computers, and some tablet computing devices may have the capability of sharing the desktop with another device. But, smart phones may not have such capability.

Each device 106 has a multimedia communication application 110 installed thereon. The multimedia communication application 110 provides users 108 of their respective devices 106 with the tools to communicate with each other using various types of media. Thus, the multimedia communication application 110 is designed for use with various types of protocols for different types of media. As described above, such protocols may include, but are not limited to, RTP, SIP, HTTP, and SMS, and as also mentioned above, the media types may include, but are not limited to, voice, video, text messaging, and screen sharing.

Each device 106 may be associated with a specific user 108. For example, the first device 106-1 is associated with the first user 108-1, the second device 106-2 is associated with the second user 108-2, the third device 106-3 is associated with the third user 108-3, and the fourth device 106-4 is associated with the fourth user 108-4. In one example, each user is associated with a unique identification string such as a SIP username. Thus, when a user of one device wishes to contact another user, he or she can use that user's unique identification string to make such contact. The conversation manager 103 can associate a user's unique identification string with a protocol address associated with that user's device. For example, the conversation manager 103 may associate a user's unique identification number with a specific Media Access Control (MAC) address or an Internet Protocol (IP) address.

In some examples, a user 108 has an account registered with the conversation manager 103. The user 108 may access his or her account through any device 106 having the multimedia communication application 110 installed thereon. When a user logs in through the multimedia communication application 110 of a specific device 106, the conversation manager 103 can register that device 106 with the unique identification number for that user. Thus, when anyone attempts to start a multimedia conversation with that user, the packet stream will be directed to the proper device. Furthermore, although not shown herein, a single user may be associated with, or logged-in at, more than one device at a time.

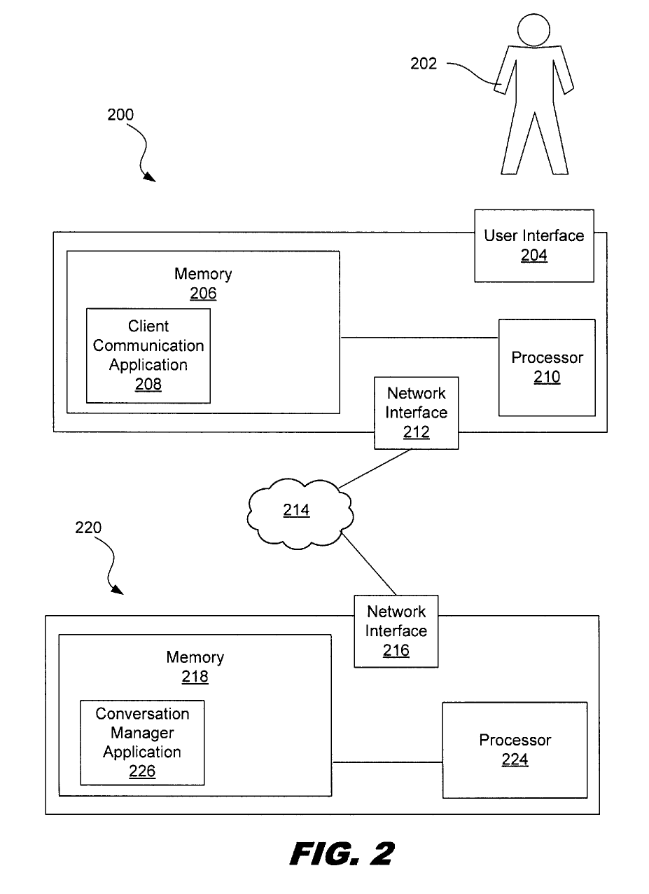

FIG. 2 is a diagram showing an illustrative client/server system. According to the present example, the client system 200 may include a user device such as a desktop computer, laptop computer, smartphone device, or tablet device. In one example, the client system 200 may correspond to a user device 106, the server system 220 may correspond to the server 102, and the network 214 may correspond to the network 105 of FIG. 1. The server system 220 can also include any appropriate hardware such as a general purpose computer or other device. An example server includes a multi-processor general purpose computer running an operating system such as Linux. The server system 220 may facilitate communication between various client devices operated by different users having the multimedia communication application 208 installed thereon. The server system 220 runs the conversation manager application 226 that serves requests from the client communication application 208 running on client devices 200.

According to certain illustrative examples, the client system 200 includes a memory 206 which may include software such as the client communication application 208. The client system 200 also includes a processor 210, a network interface 212, and a user interface 204.

The memory 206 may be one of several different types of memory. Some types of memory, such as non-volatile types of memory, typically have large storage volume but relatively slow performance. Volatile memory, such as those used for Random Access Memory (RAM), are optimized for speed and are often referred to as “working memory.” The server memory 218 may also include various types of memory 218 such as volatile or non-volatile memory. In some embodiments, the software is stored as computer-readable code in memory 206, 218 and executed by processors 210 and 224 respectively.

The client system 200 also includes a processor 210 for executing software and using or updating data stored in memory 206. The software may include an operating system and various other software applications. In addition to the communication application 208, the client device may include other software such as other communication applications, which may interface with the communication application, and other productivity applications such as word processing and web browsing.

The user interface 204 may include a number of input devices such as a keyboard, microphone, mouse, touchpad, and/or touchscreen that allow the user 202 to interact with a GUI. The user interface 204 may also include a number of different types of output devices such as audio speakers, a monitor and/or a touchscreen. The user interface allows the user 202 to interact with the client system 200.

The network interface 212 may include hardware and software that allows the client system 200 to communicate with other devices over a network 214. The network interface 212 may be designed to communicate with the network 214 through hardwire media or wireless media as appropriate. Examples of networks for use in system 214 include the Internet, a LAN, a cellular network or any other appropriate network.

According to certain illustrative examples, the server system 220 includes a memory 218 and a processor 224. The memory may have stored thereon the conversation manager application 226. The server system 220 also includes a network interface 216 for communicating with other devices such as the client system 200.

The conversation manager application 226 may be the same as or similar to the conversation manager 103 described above, and the client communication application 208 may be the same as or similar to the multimedia communication application 110 described above. The implementation of the features described above may be distributed between the server side application 226 and the client side application 208 in a variety of ways.

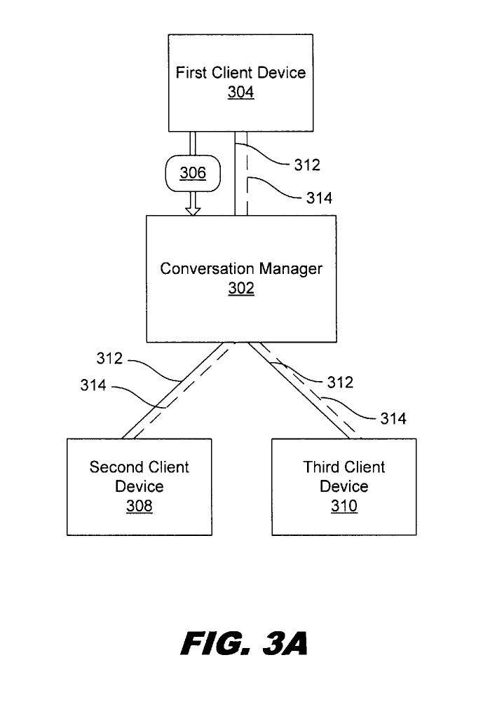

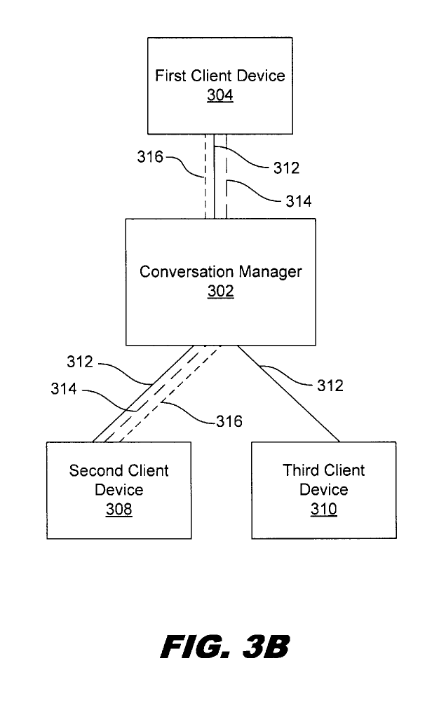

FIGS. 3A and 3B are diagrams illustrating a conversation manager establishing a conversation between multiple client devices. According to the present example, as illustrated in FIG. 3A, a first client device 304 sends a request 306 to a conversation manager 302. The request 306 instructs the conversation manager 302 to establish a conversation between the first client device 304 and a second client device 308. Additionally, the request 306 instructs the conversation manager to include a third client device 310 in the conversation.

In the present example, the conversation includes two different types of media. The first type of media is voice communication 312 represented by the solid line. The second type of media is chat communication 314 represented by the dashed line. The two different types of media 312, 314 may use different protocols for their respective communication sessions. For example, the voice communication 312 may involve an RTP protocol. The chat communication 314 may involve an SMS protocol.

The conversation manager 302 may establish the communication sessions for the different media types 312, 314 in different manners. In one example, the conversation manager 302 establishes a communication session between itself and each of the client devices 304, 308, 310, as illustrated in FIG. 3A. Thus, any communication streams between any of the client devices 304, 308, 310 pass through the conversation manager 302.

In another example, the conversation manager 302 establishes communication sessions between each of the client devices 304, 308, 310 without passing those communication sessions through the conversation manager 302. For example, the first client device 304 transfers media with both the second client device 308 and the third client device 310. But, the media itself do not pass through the conversation manager 302. Rather, the media may be routed through various routers and switches over a network such as the Internet. Additionally, the second client device 308 may transfer media with the third client device 310 through various routers and switches within the network. While such connections may not pass through the conversation manager 302, the conversation manager 302 may help establish those connections. For example, the conversation manager 302 may provide the various client devices 304, 308 310 with the physical network address and logical network address of the other client devices within the conversation. The physical network address may include a MAC address. The logical network address may include an IP address.

FIG. 3B illustrates the addition or removal of other types of media to a conversation. Specifically, during a conversation, the participants may wish to use additional media such as video conferencing, screen sharing, etc. The process of adding additional media types to a conversation is referred to as vertical escalation. The process of removing media types from a conversation is referred to as vertical de-escalation. These processes may be performed by the conversation manager 302. In the present example, the conversation includes an additional media type of video conferencing 316, represented by the dotted line.

In some examples, not all participants may be using the same type of media. For example, the first client device 304 and the second client device 308 may be involved in a video communication session 316 as well as the voice communication session 312 and the chat communication session 314. But, the third client device 310 may be involved only in the chat communication session 314.

The addition or removal of other media types may be done at the request of one of the conversation participants. For example, the conversation manager may receive a request from the first client device 304 to vertically escalate the conversation to include video communication 316. In response, the conversation manager 302 then sends invitations to clients 308, 310 with an option to join the video communication. The conversation manager 302 may then receive an indication from the second client device 308 and the third client device 310 of whether the user of that device wishes to accept or reject the video communication session 316. In the present example, the user associated with the second client device 308 accepts the request by responding accordingly to the conversation manager 302. Thus, the conversation manager 302 establishes the appropriate video communication session between the first client device 304 and the second client device 308. But, the user associated with the third client device 310 may choose to decline the request for escalating the conversation to include video communication 316. Thus, the conversation continues, but the third client device 310 is not a part of the video aspect of the conversation. But, the third client device 310 may continue with the voice communication 312.

In some cases, a participant may wish to remove a media type from the conversation. For example, the user associated with the third client device 310 may decide that he or she no longer wishes to participate in the chat aspect of the conversation. Thus, in response to a user command, the third client device 310 instructs the conversation manager 302 to discontinue the chat communication session 314 for the third client device 310. The conversation manager may then take down the data streams used to transfer chat data to and from the third client device 310. The third client device 310 may, however, continue with the voice communication 312 aspect of the conversation.

In some examples, the conversation manager adds additional users to the conversation, or removes some users from the conversation. The process of adding new users to a conversation is referred to as horizontal escalation. The process of removing users from a conversation is referred to as horizontal de-escalation. For example, the conversation manager 302 adds users to a conversation by setting up data streams between a new user's client device and the client devices 304, 308, 310 already involved in the conversation. To remove a user from a conversation, the conversation manager 302 tears down the data streams between the user's client device that is being removed and the remaining client devices associated with the conversation.

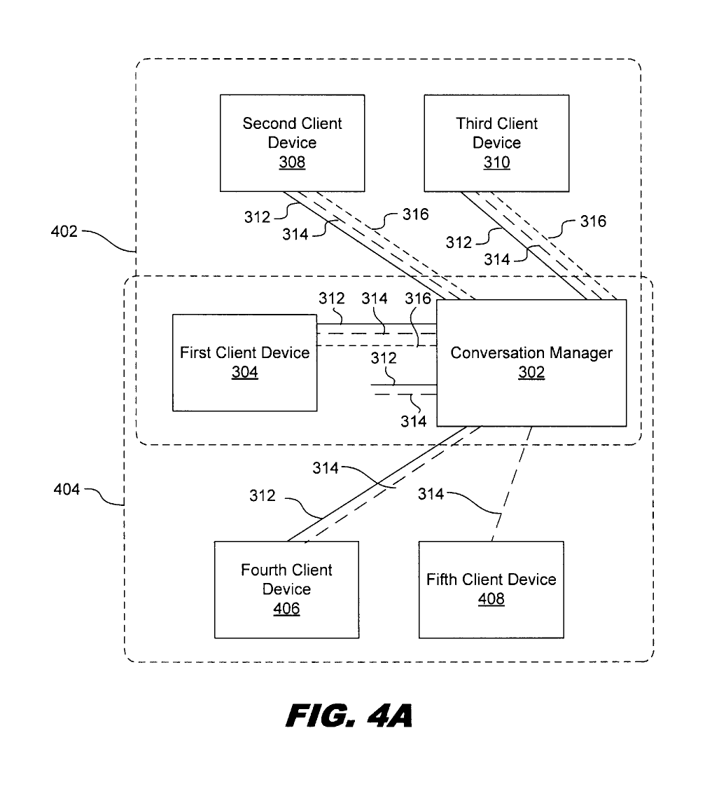

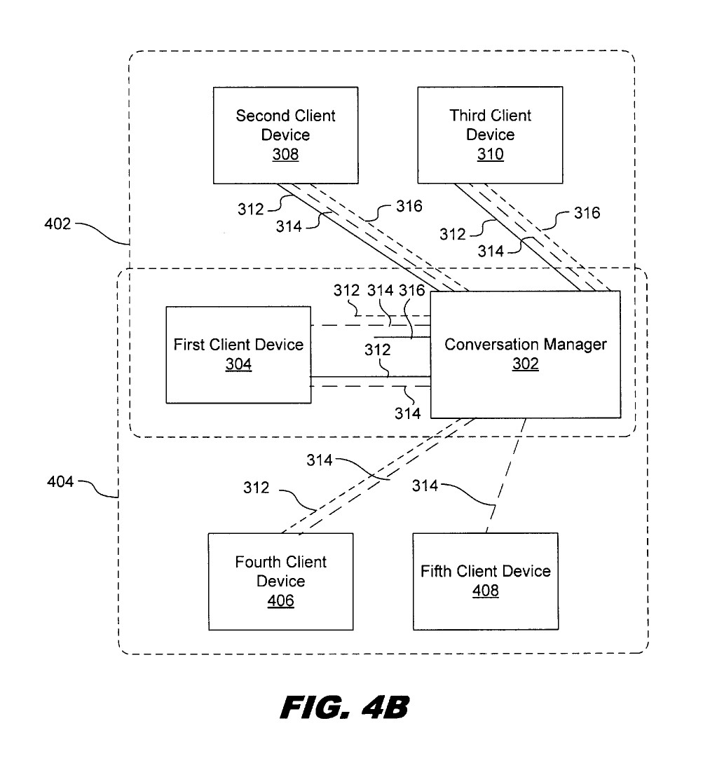

FIGS. 4A and 4B are diagrams illustrating a conversation manager 302 switching between multi-party, multimedia conversations. According to the present example, a first client device 304 is engaged in a first conversation 402 with the second client device 308 and the third client device 310. At the same time, the first client device 304 is engaged in a second conversation 404 with a fourth client device 406 and a fifth client device 408. FIG. 4A is a block diagram showing the first client device 304 engaged in two conversations, the first conversation 402 being the active conversation.

In the present example, the first client device 304 is engaged in the first conversation 402 while the second conversation 404 is in an inactive state. The inactive state will be described in further detail below. In this example, the first client device 304 is engaged in voice communication 312, chat communication 314, and video communication 316 with the second client device 308 and the third client device 310. The first conversation 402 is established by the conversation manager 302 as described above. While the first client device 304 is in an active conversation 402 with the second client device 308, and the third client device 310, the data streams for the multiple communication sessions 312, 314, 316 using different types of media are routed to the appropriate devices and reconstructed to display the video and play the audio to the user. FIGS. 4A and 4B illustrate media streams being passed through the conversation manager 302. But, as described above, some embodiments may involve the conversation manager 302 setting up streams that do not pass through the conversation manager 302.

The second conversation 404 is in an inactive state. The second conversation 404 involves a voice communication session 312 and a chat communication session 314 between the first client device 304 and the fourth client device 406. The second conversation 404 further includes a chat communication session 314 between the first client device 304 and the fifth client device 408. But, because the conversation is in an inactive state from the perspective of the first client device 304, the audio sound from the voice communication 312 data stream is not played to the user associated with the first client device 310. In one example, the media data stream is not transmitted to the first client device 304. Additionally, the chats associated with the chat communication session 314 are not being displayed to the user associated with the first client device 304. In some examples, however, the fourth client device 406 and the fifth client device 408 may still communicate using the chat communication session 314, even though the chats are not currently being displayed by the first client device 304.

FIG. 4B is a block diagram showing the first client device 304 engaged in two conversations, the second conversation 404 being the active conversation. In one example, the user of the first client device 304 may wish to switch from the first conversation 402 to the second conversation 404, thus causing the first conversation 402 to be in an inactive state. In this example, the conversation manager 302 causes the data streams from the voice communication session 312 and the video communication session 316 to no longer be transmitted to the first client device 304. In some examples, however, the data streams may still be transmitted to the first client device 304, but the first client device 304 may not display the video or play the audio to the user of the first client device 304. Additionally, in some examples, the second client device 308 and the third client device 310 may still communicate with each other over the voice communication session 312 and the video communication session 316.

The second conversation is now in an active state from the perspective of the first client device. Thus, the voice communication 312 between the first client device 304 and the fourth client device 406 is displayed to the user of the first client device 304. Additionally, the chat communication 314 between the first client device 304 and the fourth client device 406 and the fifth client device 408 is displayed to the user of the first client device 304.

The switch from the first conversation 402 to the second conversation 404 may be made in response to an instruction sent from the first client device 304 to the conversation manager 302. The instruction may be sent by the first client device 304 in response to a user command that is put in to the first client device 304. In response to receiving the instruction, the conversation manager 302 can halt data streams from the communication sessions of the first conversation 402 and open, or re-open, the data streams for the communication sessions of the second conversation 402. When the user switches back from the second conversation 404 to the first conversation 402, the conversation manager 302 then halts the data streams of the communication sessions of the second conversation 404, and re-opens the data streams of the first conversation 402.

In some examples, when the user switches from the first conversation 402 to the second conversation 404, one component of the first conversation 402 may remain active. For example, the user associated with the first client device 304 may maintain the chat communication 314 of the first conversation 402, even though the voice communication 312 and video communication 316 of the first conversation 402 are in an inactive state.

In some examples, the conversation manager 302 also manages moderator rights. In the examples of FIGS. 3A, 3B, 4A, and 4B, the first client device is the moderator. The conversation manager 302 recognizes the moderator as the client device from which it can receive certain instructions such as adding new media or adding new users to the conversation.

The conversation manager 302 may also receive an instruction from the client device having moderator rights to pass those moderators rights to a different client device. For example, if the user associated with the first client device 304 intends to switch to the second conversation 404, the user may request that the moderator rights pass to another client device within the first conversation 402. Thus, the conversation manager 302 also receives a designation of a new moderator in addition to the request to switch to the second conversation 404.

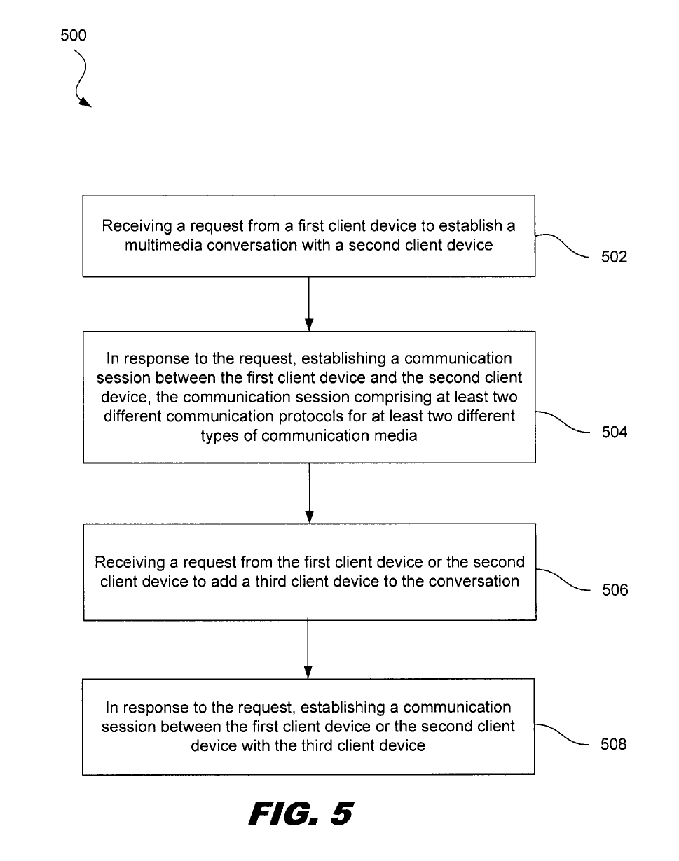

FIG. 5 is a flowchart showing an illustrative method for establishing a multi-party, multimedia conversation. According to the present example, the method 500 is performed by the conversation manager 302. For instance, the conversation manager 302 may include a program running on a server, such as server 102 of FIG. 1. Server 102 executes computer readable instructions to perform the acts of method 500. Step 502 includes receiving a request from a first client device to establish a multimedia conversation with a second client device. For example, the conversation manager 302 receives the request from first client device 304.

Step 504 includes, in response to the request, establishing a communication session between the first client device and the second client device. For example, the conversation manager 302 establishes a communication session between the first client device 304 and the second client device 308. The communication session includes at least two different communication protocols for at least two different types of communication media. In one example, the conversation includes voice communication 312 and chat communication 314, though the scope of embodiments is not limited to those media. Other embodiments may include any media type now known or later developed. Known media may include audio, video, chat, screen sharing, file sharing, whiteboarding, etc.

Step 506 includes, receiving a request from the first client device or the second client device to add a third client device to the conversation. For example, the conversation manager 302 receives a request from either the first client device 304 or the second client device, the request being to add the third client device 310 to the conversation.

Step 508 includes, in response to the request, establishing a communication session between the first client device or the second client device with the third client device. Specifically, the conversation manager 302 adds the third client device to the conversation. The conversation manager 302 is configured to add additional media types to the communication session in response to a request from one of the client devices. Establishing additional media streams can involve exchanging network addresses between the devices involved in the conversation. The conversation manager 302 may also help negotiate media exchange protocols and set up the streams associated with such media.

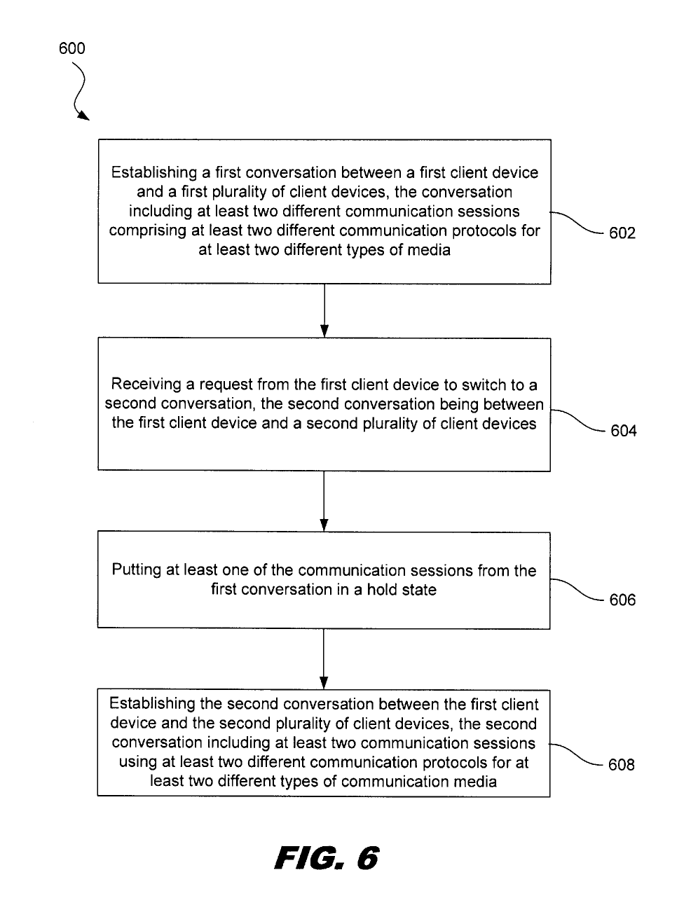

FIG. 6 is a flowchart showing an illustrative method for managing multiple multi-party, multimedia conversations. According to the present example, the method 600 is performed by a conversation manger 302. For instance, the conversation manager 302 includes a program running on a server, such as server 102 of FIG. 1. Server 102 executes computer readable instructions to perform the acts of method 600.

Step 602 includes establishing a first conversation between a first client device and a first plurality of client devices, the conversation including at least two different communication sessions comprising at least two different communication protocols for at least two different types of media. For example, the conversation manager 302 establishes a first conversation 402 that includes the first client device 304, the second client device 308, and the third client device. In some examples, the conversation manager 302 also establishes a second conversation 404 that includes the first client device 304, the fourth client device 406 and the fifth client device 408.

Step 604 includes receiving a request from the first client device to switch to the second conversation, the second conversation being between the first client device and a second plurality of client devices. For example, the conversation manager 302 may receive a command sent over the network from the first client device 304.

Step 606 includes putting at least one of the communication sessions from the first conversation in a hold state. For example, the conversation manager 302 puts the appropriate communication sessions in an inactive state as described above. Step 608 includes reactivating the second conversation between the first client device and the second plurality of client devices, the second conversation including at least two communication sessions using at least two different communication protocols for at least two different types of communication media. Specifically, the conversation manager 302 reactivates the second conversation 404 as described above.

Some examples of processing systems described herein may include non-transitory, tangible, machine readable media that include executable code that when run by one or more processors (e.g., processor 210, 224) may cause the one or more processors to perform the processes of methods 500 and 600 as described above. Some common forms of machine readable media that may include the processes of methods 500 and 600 are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A method performed by a conversation manager on a server in a communications network, the method comprising:
receiving a request from a first client device to establish a multimedia conversation with a second client device;
in response to the request, establishing a communication session between the first client device and the second client device, the communication session comprising at least two different communication protocols for at least two different types of communication media;
receiving a request from the first client device or the second client device to add a third client device to the conversation;
in response to the request, establishing a communication session between the first client device or the second client device with the third client device;
wherein the conversation manager is configured to add additional media types to the communication session in response to a request from one of the client devices.
